(19) United States
(12) Patent Application Publication
(10) Pub. No.: US 2016/0353527 A1
(43) Pub. Date: Dec. 1, 2016

(54) Customized Retainer for Induction Heating Coil

(71) Applicant: Caterpillar Inc., Peoria, IL (US)

(72) Inventors: Huijun Wang, Peoria, IL (US); Michael H. Noble, Peoria, IL (US); Donald Stickel, Chillicothe, IL (US); Howard W. Ludewig, Groveland, IL (US)

(73) Assignee: CATERPILLAR INC., Peoria, IL (US)

(21) Appl. No.: 14/727,209

(22) Filed: Jun. 1, 2015

(51) Int. Cl. H05B 6/10; C21D 9/50; B22D 25/02; H05B 6/36; B29C 67/00

(52) U.S. Cl. CPC H05B 6/101; H05B 6/36; B29C 67/0055; B22D 25/02; C21D 9/50; B29K 2105/0058

(57) ABSTRACT

An induction heating apparatus for heat-treating a joint disposed between two work pieces. The apparatus may include a retainer that has an inner surface. The inner surface of the retainer has a profile that corresponds to a profile of the joint and portions of the work pieces. The inner surface of the retainer may further include a groove for accommodating an inductor. The inductor has a first end connected to a first terminal of a radio frequency electric current source. The inductor extends from the first terminal and along the groove before terminating at the second end that connects to a second terminal of the radio frequency electric current source.

### BACKGROUND

Technical Field

This disclosure relates generally to welding large structures and more particularly to the use of induction heating coils or inductors for heating a joint before and/or after welding and for heating a weld joint for stress relief purposes.

Description of the Related Art

Induction heating is the process of heating an electrically conductive work piece, such as a metal work piece, by electromagnetic induction. An induction heating apparatus may include an induction coil or an inductor energized with a radio-frequency electric current. The inductor wraps around the work piece and the radio-frequency electric current energizes the inductor and generates a high-frequency alternating electromagnetic field that penetrates the work piece and generates eddy currents in the work piece. The eddy currents generate heat within the work piece through resistive heating, also referred to as Joule heating. Further, in a ferromagnetic work piece, hysteresis also generates heat as the alternating electromagnetic field repeatedly magnetizes and de-magnetizes the iron crystals. This rapid flipping of the magnetic domains of the iron crystals causes friction and heating inside the ferromagnetic work piece. In practice, induction heating produces heat in most materials that is a combination of resistive heating and hysteresis.

Induction heating generates heat inside a work piece itself, in contrast to using an external heat source, such as an oven, which heats a work piece primarily though conduction, convection and radiation, all of which are slower processes than induction heating. Further, for large work pieces, moving the work piece into an oven can be time consuming, expensive and a safety issue. As a result, manufacturers employ induction heating for preheating, post-heating and stress relief of joints between large work pieces. Induction heating is most effective for tubular joints having simple geometries, such as round or rectangular cross-sectional shapes because the inductor can be wrapped around the weld joint and held close to the weld joint. As a result, the distance between the inductor and the weld joint is uniform and the weld joint heats evenly and simultaneously.

However, for work pieces with irregular geometries, simply wrapping the inductor around the work piece or weld joint is less effective because the distance between the inductor and the joint is non-uniform and therefore the heating of the joint will be non-uniform. Thus, for joints between work pieces with irregular geometries, heat-treatments are performed in an oven, which is slower, more expensive and inconvenient, especially for large work pieces.

US2012/0125919 discloses various induction heating apparatuses, but none of the apparatuses disclosed therein includes a means for retaining the position of the inductor uniformly close to a joint having an irregular geometry.

### SUMMARY OF THE DISCLOSURE

In one aspect, this document encloses an induction heating apparatus for heat-treating a joint disposed between two work pieces. The joint and portions of the two work pieces form a first profile. The induction heating apparatus may include a retainer having one or more inner surfaces that form a second profile that corresponds to the first profile of the joint. The one or more inner surfaces may further include one or more grooves for accommodating an inductor. The inductor may have a first end connected to a first terminal of a radio frequency electric current source. The inductor may extend from the first terminal and along the groove before terminating at a second end connected to a second terminal of the radio frequency radio electric source.

In another aspect, this document discloses a method for heat-treating a joint of a work piece. The method may include creating a three-dimensional digital model of the work piece and the joint. The method may also include creating a digital reverse impression of the three-dimensional digital model. The method may further include creating a groove in the digital reverse impression to provide a modified digital reverse impression. The groove may form a spiral pattern around a portion of the digital reverse impression corresponding to the joint. The method may further include delivering the modified digital reverse impression to one of an additive manufacturing (AM) machine or a computerized numerical control (CNC) machine. The method may further include creating a retainer from the modified digital reverse impression. The method may further include providing an inductor having a first end and a second end and providing a radio frequency electrical current source having a first terminal and a second terminal. The method may further include connecting the first end of the inductor to the first terminal, extending the inductor along the groove and connecting the second end of the inductor to the second terminal. The method may further include connecting the radio-frequency electrical current source to a power source.

In another aspect, this document discloses a method for making a retainer for an inductor of an induction heating apparatus. The method may include creating a three-dimensional digital model of a work piece having an irregularly shaped joint. The method may further include creating a digital reverse impression of the three-dimensional digital model. The method may further include creating a groove in the digital reverse impression to provide a modified digital reverse impression. The groove may surround a portion of the digital reverse impression corresponding to the irregularly shaped joint. The method may further include delivering the modified digital reverse impression to one of an additive manufacturing (AM) machine or a computerized numerical control (CNC) machine and creating a retainer from the modified digital reverse impression.

The features, functions, and advantages discussed above may be achieved. independently in various embodiments or may be combined in yet other embodiments, further details of which can be seen with reference to the following description and drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a perspective view of an excavator that includes a stick and a track roller frame, each of which have one or more weld joints that may be heat-treated using an induction heating apparatus and/or method in accordance with this disclosure.

FIG. 2 is a perspective view of a retainer for heat-treating a portion of a longitudinal joint formed in the stick shown in FIG. 1.

FIG. 3 is another perspective view of the retainer shown in FIG. 2 with an inductor positioned in the grooves of the retainer.

FIG. 4 a perspective view of an induction heating apparatus that includes the retainer and inductor shown in FIG. 3.

FIG. 5 is an end view of the retainer and inductor shown in FIGS. 3-4.

FIG. 6 is a partial perspective view of the retainer and inductor shown in FIGS. 3-5.

FIG. 7 is a partial perspective and sectional view of the retainer and inductor shown in FIGS. 3-6.

FIG. 8 is a perspective view of a retainer positioned around a track roller frame for the excavator shown in FIG. 1.

FIG. 9 is a plan view of a gear having weld joints that may be heat-treated using retainers, inductors and methods disclosed herein.

FIG. 10 is a sectional view taken substantially taken along line 10-10 of FIG. 9.

FIG. 11 is a perspective view of a retainer and inductor for preheating one of the inner weld joints of the gear shown in FIGS. 9-10.

FIG. 12 is a perspective view of a plurality of retainers like that shown in FIG. 6 arranged for heat-treating a portion of the outer periphery of the gear shown in FIGS. 9-12.

The drawings are not necessarily to scale and illustrate the disclosed embodiments diagrammatically and in partial views. In certain instances, this disclosure may omit details which are not necessary for an understanding of the disclosed methods and apparatuses or which render other details difficult to perceive. Further, this disclosure is not limited to the particular embodiments illustrated herein.

### DETAILED DESCRIPTION

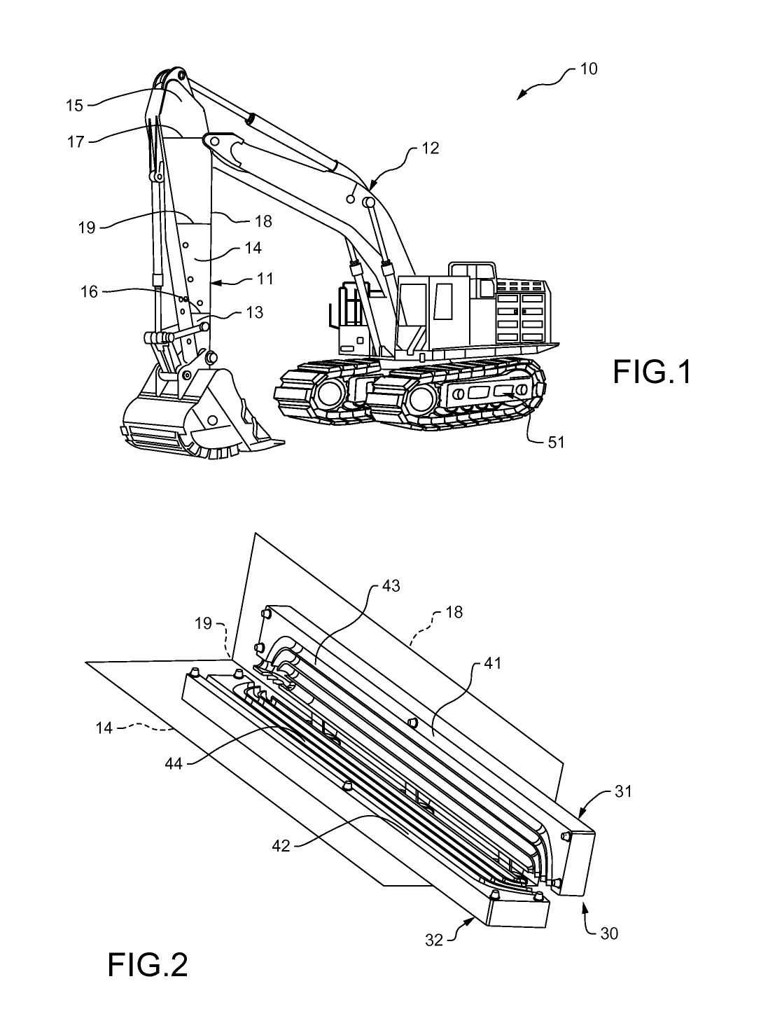

FIG. 1 illustrates an excavator 10, which is one of many different types of machines that include welded joints between parts or components referred to herein as “work pieces.” For example, one or more weld joints may be disposed in the stick 11 or boom 12. Specifically, the stick lit may include work pieces 13, 14, 15 secured together by transverse welds to form the joints 16, 17. Further, a longitudinal weld connects the work piece 14 to the work piece 18 to form the longitudinal joint 19.

Pre-heating, post-heating and/or heat-treating the joints 16, 17, 19 is problematic for a number of reasons. First, the stick 11 is obviously a large and heavy component. Utilizing a conventional oven for heat-treating various portions of the stick 11 is difficult because the stick 11 must be moved into such an oven and the oven must be large enough to accommodate the stick 11. Further, for weld repairs, the entire stick 11 does not need to be heated, but only localized areas of the stick 11. Consequently, heat-treating the stick 11 in a conventional oven is inefficient and induction heating is a faster, safer and less expensive.

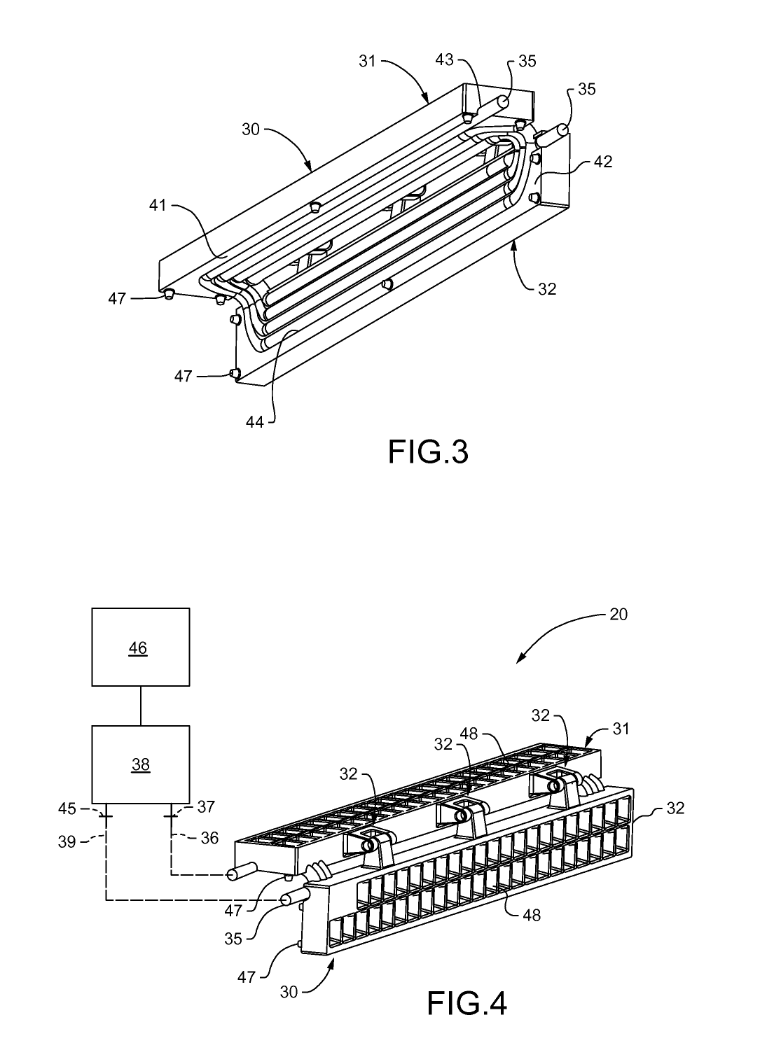

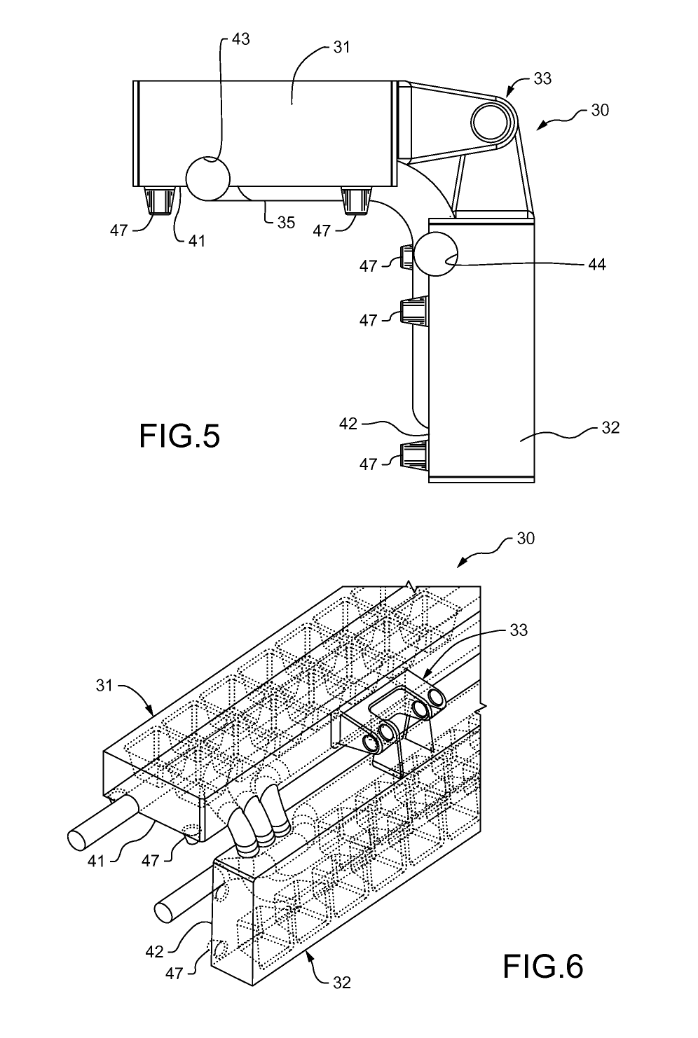

Turning to FIGS. 2-7, to heat-treat a portion of the longitudinal joint 19, an induction heating apparatus 20 (FIG. 4) may include a customized retainer 30. As shown in FIG. 2, the work piece 18 connects to the work piece 14 at the longitudinal joint 19. Wrapping an inductor transversely around stick 11 to heat the joint 19 would result in the entire periphery of the stick 11 being heated, which would be inefficient. Therefore, to surround a portion of the longitudinal joint 19 with an inductor 35 (FIG. 3), the retainer 30 may include a first block 31 coupled to a second block 32 by one or more hinges 33 (FIGS. 4-5). As an alternative, the blocks 31, 32 may be fixedly connected together or formed as a unitary structure. Each block 31, 32 includes in an inner surface 41, 42 (FIG. 2). The inner surface 41 has a profile that matches or corresponds to a profile of the work piece 18 white the inner surface 42 has a profile that matches or corresponds to a profile of the work piece 14.

Each inner surface 41, 42 includes at least one groove 43, 44. The grooves 43, 44 accommodate an inductor 35 and the grooves 43, 44 may collectively form a coil pattern as illustrated in FIG. 3. When the inductor 35 is placed in the grooves 43, 44, the inductor 35 forms a plurality of loops or coils that surround a portion of the longitudinal joint 19 when the joint 19 is positioned at the hinged connection between the blocks 31, 32 as shown in FIG. 2. The coiled pattern of the inductor 35 provides the greatest maximum flux at the center of the coils (FIG. 3) and therefore the greatest maximum flux along the portion of the joint 19 (FIG. 2) to be heated.

An induction heating apparatus 20 is shown in FIG. 4. Each block 31, 32 of the retainer 30 may include a plurality of pockets 48 that provide additional surface area for the dissipation of heat. The inductor 35 may include a first end 36 that connects to a first terminal 37 of a radio frequency electric current source 38. The inductor 35 may also include a second end 39 that connects to a second terminal 45 of the radio frequency electric current source 38. The radio frequency electric current source 38, in turn, may connect to a power supply 46.

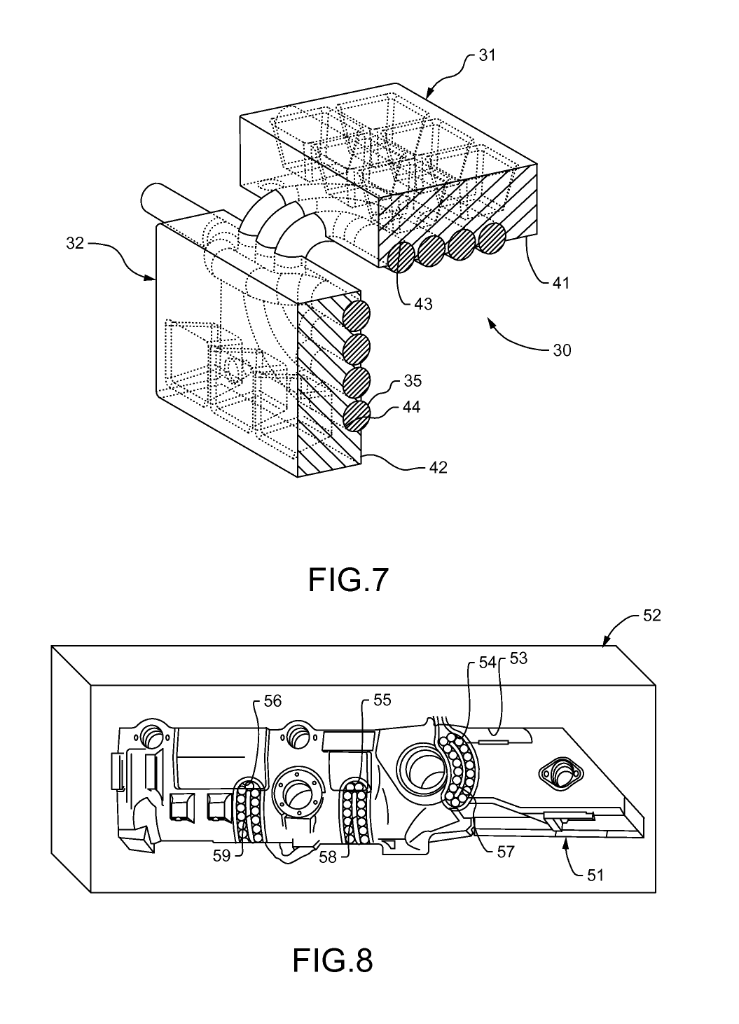

As shown in FIG. 5, each inner surface 41, 42 may include pegs 47 that maintain the work pieces 14, 18 at a fixed distance from the inductor 35. The fixed distance between the inductor 35 and the work pieces 14, 18 provided by the pegs 47 may, for example, be about 6 mm, but the desired spacing may vary, depending upon the characteristics of the work pieces 14, 18, the joint 19 and the inductor 35 and the purpose of the heat-treatment. Additional details of the grooves 43, 44 that enable the coil pattern for the inductor 35 are illustrated in FIGS. 6-7.

The customized retainer 30 includes one or more inner surfaces 41, 42 that have profiles that correspond to profiles of the work pieces 18, 14 respectively so a portion of the joint 19 that needs heat-treatment can be placed between the blocks 31, 32 as shown in FIG. 2. Further, the grooves 43, 44 form an elongated coil or spiral pattern around the joint 19. When energized, the magnetic flux produced by the inductor 35 will be concentrated along the portion of the joint 19 disposed within the loops. As a result, the portion of the joint 19 disposed within the loops will be heated quickly and in a uniform manner.

The excavator 10 of FIG. 1 may also include a track roller frame 51. FIG. 8 illustrates a retainer 52 that is essentially a mold of the track roller frame 51. Specifically, the retainer 52 includes an inner surface 53 that faces the track roller frame 51 and that has a profile that matches or corresponds to (or is a reverse impression of) the outer surface of the track roller frame 51. The inner surface 53 of the retainer 52 may also include one or more grooves 54, 55, 56 that are strategically placed around the joints 57, 58, 59. In the embodiment shown in FIG. 8, three separate inductors may be employed or single inductor may be employed for all three joints 57, 58, 59.

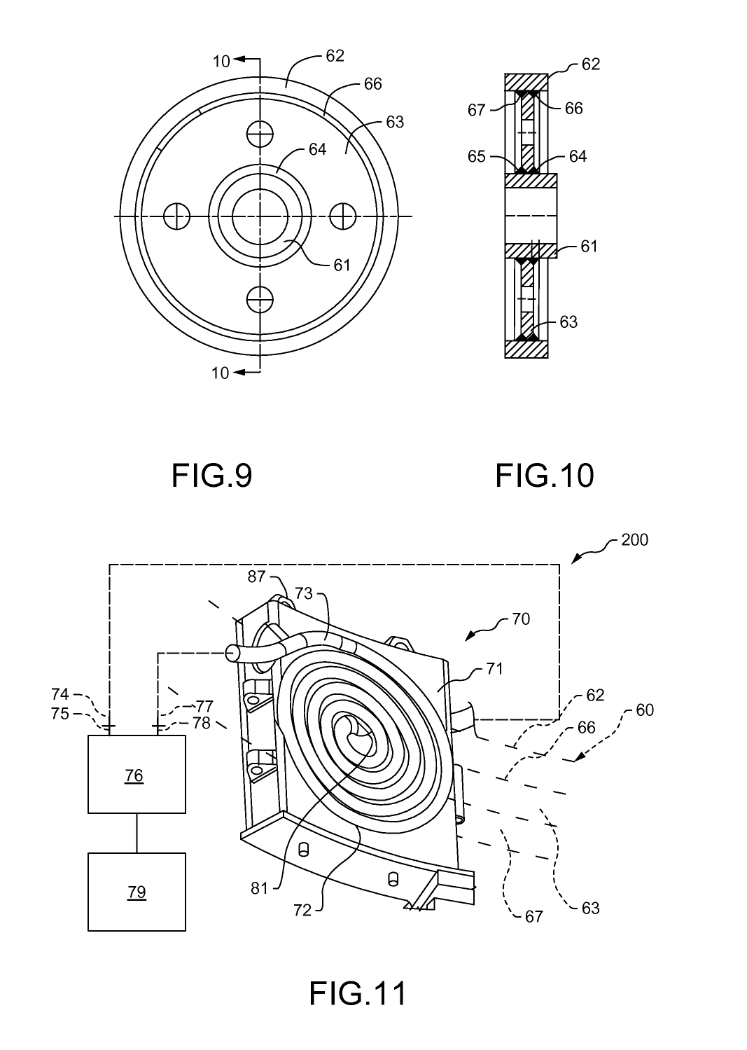

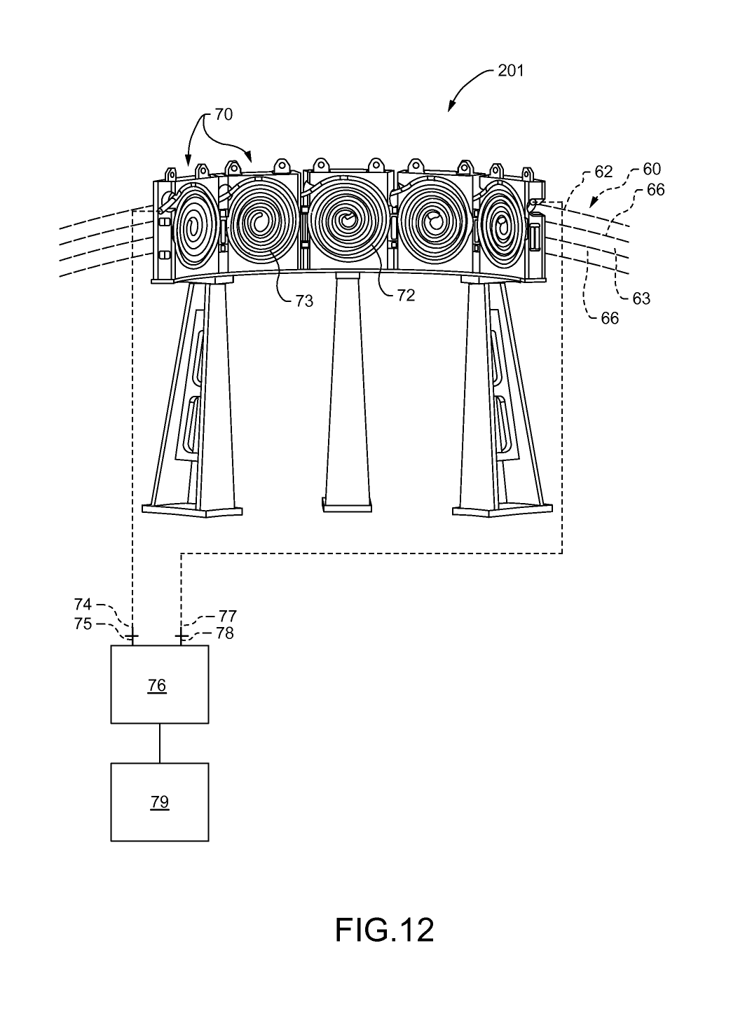

Another example of a component having one or more joints that are difficult to preheat is the large gear 60 of FIGS. 9-10. Specifically, the gear 60 includes an inner ring or work piece 61 connected to an outer ring or work piece 62 by a middle ring or work piece 63. The work piece 63 connects to the work piece 61 at the joints 64, 65 and to the work piece 62 at the joints 66, 67. Preheating of the joints 66, 67 is greatly facilitated by employing one or more retainers 70 and the induction heating apparatuses 200, 201 illustrated in FIGS. 11-12.

As shown in FIG. 11, the retainer 70 includes an inner surface 71 with a concave profile that corresponds to a profile of the work piece 62 of the gear 60. Essentially, the inner surface 71 of the retainer 70 is a reverse impression of a portion of the work piece 62 of the gear 60 as shown schematically in FIG. 11. As shown in FIG. 12, a plurality of such retainers 70 may be employed to a heat longer section of the joints 66, 67. Like the retainers 30, 52 shown in FIGS. 2-8, the inner surface 71 of each retainer 70 also includes a groove 72, which accommodates an inductor 73. As shown in FIGS. 11-12, the grooves 72 and inductors 73 may form a coiled pattern where the greatest maximum flux will be concentrated towards the center of the coil. Hence, as shown in FIG. 11, the retainer 70 should be positioned so the joints 66, 67 are in alignment with the center of coil.

Further, as shown in FIG. 11, the inductor 73 may include a first end 74 that connects to first terminal 75 of a radio frequency electric current source 76. The inductor 73 may also include a second end 77 that connects to a second terminal 78 of the radio frequency electric current source 76. Further, the radio frequency electric current source 76 may connect to a power supply 79. As shown in FIG. 12, the inductors 73 may link together in series between the first and second terminals 75, 78 of the radio frequency electric current source 76. Alternatively, each inductor 73 may connect to its own dedicated radio frequency electric current source 76.

The retainers 30, 52, 70 may be fabricated from a variety of means, including additive manufacturing (AM) and computerized numerical control (CNC) machining. Further, three-dimensional (3D) printing is one form of additive manufacturing that may be particularly useful. The retainers 30, 52, 70 may be fabricated from a variety of materials including, but not limited to plastics, stainless steels and aluminum alloys. The material of construction for the retainers 30, 52, 70 must have a suitably high heat deformation temperature (HDT).

### INDUSTRIAL APPLICABILITY

Improved induction heating apparatuses 20, 200, 201 are disclosed for heat-treating a joint 19, 57, 58, 59, 66, 67 disposed between two work pieces 14, 18, 62, 63. The induction heating apparatuses 20, 200, 201 may include a retainer 30, 52, 70 that has an inner surface 41, 42, 53, 71 that may essentially be a reverse impression of at least part of the joint 19, 57, 58, 59, 66, 67 and the work pieces 14, 18, 62, 63 disposed on either side of the joint 19, 57, 58, 59, 66, 67. The inner surface 41, 42, 53, 71 may include a groove 34, 54, 55, 56, 72 for accommodating an inductor 35, 73. The inductor 35, 73 may have a first end 36, 74, connected to a first terminal 37, 75 of a radio frequency electric current source 38, 76. The inductor 35, 73 may extend from the first terminal 37, 75 and along the groove 34, 72 before terminating at a second end 39, 77 that may connect to a second terminal 45, 78 of the radio frequency electric current source 38. Further, the radio frequency electric current source 38, 76 may be connected to a power supply 46, 79. The retainers 30, 52, 70 provide consistent spacing between the inductor 35, 73 and the joints 19, 57, 58, 59, 66, 67. The retainers 30, 52, 70 may be fabricated using AM and/or CNC machining techniques. One suitable AM process is 3D printing.

The inductor 35, 73 may be an elongated wired-typed conductor having a generally circular cross-sectional profile. The inductors 35, 73 may be accommodated in the grooves 34, 72 of the retainers 30, 70 so that about half of the cross-sectional profile of the inductor 35, 75 is accommodated in its respective groove 34, 72. The groove 72 may include an inlet 81 and an outlet 82 and the groove 72 may form a spiral pattern between the let 81 and the outlet 82. The inlet 81 may be disposed at a center of the spiral pattern and the outlet 82 may be disposed at an outer edge of the retainer 70 as shown in FIG. 11. In other embodiments, the retainer 52 substantially surrounds the joint 57, 58, 59. Further, the retainer 30, 52, 70 may be fabricated from a variety of materials, including plastics, stainless steels and aluminum alloys.

Methods for heat-treating a joint 19, 66, 67, disposed between two work pieces 14, 18, 62, 63 may include creating a three-dimensional digital model of at least a portion of the work pieces 14, 18, 62, 63 and the joint 19, 66, 67. The method may also include creating a digital reverse impression of the three-dimensional digital model. The method may further include creating a groove 34, 72 in the digital reverse impression to provide a modified digital reverse impression. The groove 34, 72 may surround a portion of the digital reverse impression that corresponds to the joint 19, 66, 67. The method may further include delivering the modified digital reverse impression to one of an additive manufacturing (AM) machine or a computerized numerical control (CNC) machine. The method may further include creating a retainer from the modified digital reverse impression, providing an inductor 35, 73 having a first end 36, 74 and a second end 39, 77 and providing a radio frequency electric current source 38, 76 having a first terminal 37, 75 and a second terminal 45, 78. The method may further include connecting the first end 36, 74 of the inductor 35, 73 to the first terminal 37, 75, extending the inductor 35, 73 along the groove 34, 72 and connecting the second end 39, 77 to the second terminal 45, 78. The method may further include connecting the radio frequency electric current source 38, 76 to a power supply 46, 79.

A method for making a retainer 30, 52, 70 for an induction heating apparatus 20, 200, 201 is disclosed. The method may include creating a three-dimensional digital model of at least part of two work pieces 14, 18, 62, 63 having an irregularly shaped joint 19, 66, 67 disposed there between. The method may further include creating a digital reverse impression of the three-dimensional digital model. The method may further include creating a groove 34, 54, 55, 56, 72 in the digital reverse impression to provide a modified digital reverse impression. The groove 34, 54, 55, 56, 72 may surround at least a portion of the digital reverse impression corresponding to the irregularly shaped joint 19, 57, 58, 59, 66, 67. The method may further include delivering the modified digital reverse impression to one of an additive manufacturing (AM) machine or a computerized numerical control (CNC) machine and the method may further include creating a retainer the modified digital reverse impression.

While only certain embodiments of been set forth, alternative embodiments and various modifications will be apparent from the above description to those skilled in the art. These and other alternatives are considered equivalents and within the spirit and scope of the present disclosure.

Parts

| Number | Part Names |
|---|---|
| 10 | excavator |
| 11 | stick |
| 12 | boom |
| 13 | work piece |
| 14 | work piece |
| 15 | work pieces |
| 16 | joint |
| 17 | joint |
| 18 | work pieces |
| 19 | joint |
| 20 | induction heating apparatus |
| 30 | retainer |
| 31 | block |
| 32 | block |
| 33 | hinge |
| 34 | groove |
| 35 | inductor |
| 36 | first end |
| 37 | first terminal |
| 38 | radio frequency electric current source |
| 39 | second end |
| 41 | inner surface |
| 42 | inner surface |
| 43 | groove |
| 44 | groove |
| 45 | second terminal |
| 46 | power supply |
| 47 | peg |
| 48 | pocket |
| 51 | track roller frame |
| 52 | retainer |
| 53 | inner surface |
| 54 | groove |
| 55 | groove |
| 56 | groove |
| 57 | joint |
| 58 | joint |
| 59 | joint |
| 60 | gear |
| 61 | work piece |
| 62 | work piece |
| 63 | work piece |
| 64 | joint |
| 65 | joint |
| 66 | joint |
| 67 | joint |
| 70 | retainer |
| 71 | inner surface |
| 72 | groove |
| 73 | inductor |
| 74 | first end |
| 75 | first terminal |
| 76 | radio frequency electric current source |
| 77 | second end |
| 78 | second terminal |
| 79 | power supply |
| 81 | inlet |
| 82 | outlet |
| 200 | induction heating apparatus |
| 201 | induction heating apparatus |

What is claimed:

1. An induction heating apparatus for heat-treating a joint disposed between two work pieces, the joint having a first profile, the apparatus comprising:
a retainer having one or more inner surfaces that forms a second profile that corresponds to the first profile of the joint, the one or more inner surfaces including one or more grooves for accommodating an inductor,
the inductor having a first end connected to a first terminal of a radio frequency electric current source, the inductor extending from the first terminal and along the one or more grooves before terminating at a second end connected to a second terminal of the radio frequency electric current source.

2. The induction heating apparatus of claim 1 wherein the retainer is fabricated by additive manufacturing (AM).

3. The induction heating apparatus of claim 1 wherein the retainer is fabricated by three-dimensional (3D) printing.

4. The induction heating apparatus of claim 1 wherein the retainer is fabricated by computerized numerical control (CNC) machining.

5. The induction heating apparatus of claim 1 wherein the inductor has a generally circular cross-sectional profile and the one or more grooves accommodate about half of the cross-sectional profile of the inductor.

6. The induction heating apparatus of claim 1 wherein the one or more grooves form a spiral pattern.

7. The induction heating apparatus of claim 1 wherein the retainer includes a first inner surface disposed on a first block and a second inner surface disposed on a second block hingedly connected to a first block, the first and second inner surfaces each including at least one groove for accommodating the inductor, the grooves of the first and second inner surfaces forming an elongated coil pattern with a center of the elongated coil pattern at least partially surrounding the joint.

8. The induction heating apparatus of claim 1 wherein the second profile of the retainer is a reverse impression of the first profile of the joint.

9. The induction heating apparatus of claim 1 wherein the retainer is fabricated from a plastic.

10. A method for heat-treating a joint disposed between two work pieces, the method comprising:
creating a three-dimensional digital model of the work pieces and the joint;
creating a digital reverse impression of the three-dimensional digital model;
creating a groove in the digital reverse impression to provide a modified digital reverse impression, the groove forming a spiral pattern around a portion of the digital reverse impression corresponding to the joint;
delivering the modified digital reverse impression to one of an additive manufacturing (AM) machine or a computerized numerical control (CNC) machine;
creating a retainer from the modified digital reverse impression;
providing an inductor having a first end and a second end and providing a radio frequency electric current source having a first terminal and a second terminal;
connecting the first end of the inductor to the first terminal, extending the conductor along the groove and connecting the second end of the inductor to the second terminal; and
connecting the radio frequency electric current source to a power source.

11. The method of claim 10 wherein the modified digital reverse impression is delivered to a three-dimensional (3D) printer.

12. The method of claim 10 wherein the inductor has a generally circular cross-sectional profile and the groove accommodates about half of the cross-sectional profile of the inductor.

13. The method of claim 10 wherein the groove includes an inlet and an outlet and the groove forms a spiral pattern between the inlet and the outlet.

14. The method of claim 13 wherein the inlet of the groove is disposed at a center of the spiral pattern and the outlet is disposed at an outer edge of the retainer.

15. The method of claim 10 wherein the retainer is fabricated from a plastic.

16. A method for making a retainer for an inductor of an induction heating apparatus, the method comprising:
creating a three-dimensional digital model of at least part of two work pieces having a joint disposed there between;
creating a digital reverse impression of the three-dimensional digital model;
creating a groove in the digital reverse impression to provide a modified digital reverse impression, the groove surrounding at least a portion of the digital reverse impression corresponding to the joint;
delivering the modified digital reverse impression to one of an additive manufacturing (AM) machine or a computerized numerical control (CNC) machine; and
creating a retainer from the modified digital reverse impression.

17. The method of claim 16 wherein the modified digital reverse impression is delivered to a three-dimensional (3D) printer.

18. The method of claim 16 wherein the inductor has a generally circular cross-sectional profile and the groove accommodates about half of the cross-sectional profile of the inductor.

19. The method of claim 16 wherein the groove includes an inlet and an outlet and the groove forms a spiral pattern between the inlet and the outlet.

20. The method of claim 19 wherein the inlet of the groove is disposed at a center of the spiral pattern and the outlet is disposed at an outer edge of the retainer.
